(19) United States
(12) Patent Application Publication
(10) Pub. No.: US 2026/0341978 A1
(43) Pub. Date: Oct. 29, 2026

(54) TURNSTILE ANTENNA WITH DUAL-PLANE POLARIZATION

(71) Applicant: Volodymyr VERBONOL, Dnipro (UA)

(72) Inventor: Volodymyr VERBONOL, Dnipro (UA)

(21) Appl. No.: 19/390,628

(22) Filed: Nov. 16, 2025

(30) Foreign Application Priority Data
Apr. 25, 2025 (DE) 202025102276.1

(51) Int. Cl. H01Q 21/26; H01Q 21/20; H01Q 21/24

(52) U.S. Cl. CPC H01Q 21/26; H01Q 21/20; H01Q 21/245

(57) ABSTRACT

A turnstile antenna includes radiating elements shaped as isosceles triangles arranged in a horizontal plane with a central gap. Distal ends of the elements are bent downward to form vertical rectangular sections, enabling transmission and reception with both horizontal and vertical polarization components. A bridge-type balancing network couples the elements to a coaxial feed to balance the elements and maintain a low voltage standing wave ratio. The antenna supports an approximately circular radiation pattern across centimeter-wave and decimeter-wave frequency bands.

### CROSS-REFERENCE TO RELATED APPLICATIONS

This application claims the benefit of foreign priority under 35 U.S.C. § 119(a) to German Utility Model Application No. 20 2025 102 276.1, filed Apr. 25, 2025. The entire contents of the foregoing application are incorporated by reference herein.

### BACKGROUND OF THE INVENTION FIELD

The present disclosure relates to radio antennas, and more particularly to broadband turnstile antenna systems capable of supporting both horizontal and vertical polarization for use in radionavigation and related systems.

### BACKGROUND

The closest prior art appears to be Russian Patent RU 2643700 C1, which discloses a turnstile antenna having radiating elements formed from metal sheets shaped as four isosceles triangles arranged in a single plane in a cross configuration. That design supports only horizontally orthogonal polarization and is not compatible with systems requiring vertical polarization components.

### SUMMARY

In one aspect, a turnstile antenna is provided that transmits and receives electromagnetic waves having both horizontal and vertical polarization components. Distal portions of the radiating elements are bent downward from the plane of the antenna by an angle between about 90° and about 130° to form vertical rectangular sections. A bridge-type balancing network including capacitive and inductive elements couples the radiating elements to a feed (e.g., a coaxial cable) to balance the elements and maintain a low Voltage Standing Wave Ratio (VSWR) across the operating band. The configuration enables an approximately circular azimuthal radiation pattern and broadens the functional bandwidth of the antenna.

### BRIEF DESCRIPTION OF THE DRAWINGS

FIG. 1 is a perspective view of a turnstile antenna according to certain embodiments.

FIG. 2 is a bottom view of the antenna of FIG. 1.

### DETAILED DESCRIPTION

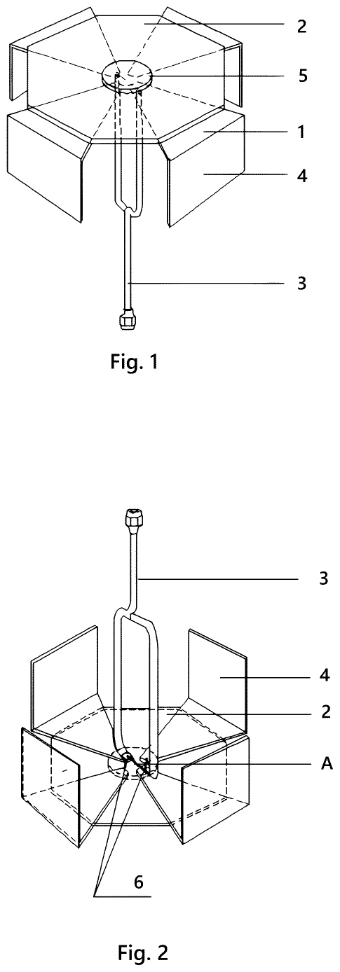

Referring to FIGS. 1-2, a turnstile antenna (10) includes radiating elements (12) formed from metal sheets shaped as four isosceles triangles arranged in a horizontal plane in a cross configuration with a central gap between vibrators (A). FIG. 1 displays vibrators (1), an antenna base (2), a coaxial cable (3), bent sections of vibrators (4), and a capacitive matching pert (5). FIG. 2 displays the antenna base (2), an inductive matching part (6), the coaxial cable (3), the bent sections of vibrations (4), and the central gap (A). The reference numerals (5) and (6) represent a bridge balancing device.

The radiating elements define two orthogonal dipoles and are mounted to a base (14). At locations distal from the central gap, ends of the elements are bent downward by an angle between about 90° and about 130° to form rectangular sections (16) that extend in a vertical plane.

The elements are fed by a coaxial cable (18). In certain embodiments, the bend width is about 35-45 mm, and the triangle height is about 50-95 mm. The vertical sections preferably have a height of at least about 15 mm to provide three substantially orthogonal polarization components over a broad frequency range.

A bridge-type balancing network (20) couples the elements (12) to the coaxial feed (18) and includes inductive components implemented as coils positioned between the orthogonal radiating elements. The horizontal triangular portions primarily support horizontal polarization, while the vertical bent portions primarily support vertical polarization.

In some embodiments, the antenna operates as a narrowband antenna in centimeter-wave frequencies and as a broadband antenna in decimeter-wave frequencies. The balancing network can maintain a VSWR of no more than about 1.4 across the operating band. The antenna is compact, manufacturable with conventional sheet-metal processes, and may be installed within a radio-transparent protective radome.

1. A turnstile antenna, comprising:
radiating elements formed from metal sheets shaped as four isosceles triangles arranged in a horizontal plane in a cross configuration with a central gap;
a base to which the radiating elements are mounted; and
a coaxial feed coupled to the radiating elements, wherein distal portions of the radiating elements are bent downward by an angle between about 90° and about 130° to form rectangular sections disposed in a vertical plane.

2. The turnstile antenna according to claim 1, further comprising
a bridge-type balancing network configured as a generally planar structure coupling the radiating elements to the coaxial feed, wherein
the balancing network comprises inductive elements implemented
as coils positioned between orthogonal radiating elements.
